(19) United States
(12) Patent Application Publication
(10) Pub. No.: US 2026/0122488 A1
(43) Pub. Date: Apr. 30, 2026

(54) Secure Wireless Communication Between an Implantable Medical Device and an External Device

(71) Applicant: TC1 LLC, St.Paul, MN (US)

(72) Inventor: Ding Ma, Inverness, IL (US)

(73) Assignee: TC1 LLC, St. Paul, MN (US)

(21) Appl. No.: 19/425,273

(22) Filed: Dec. 18, 2025

Related U.S. Application Data
(63) Continuation of application No. PCT/US2024/035297, filed on Jun. 24, 2024.
(60) Provisional application No. 63/524,565, filed on Jun. 30, 2023.

(51) Int. Cl. H04W 12/06; H04L 9/08; H04W 12/03; H04W 12/043

(52) U.S. Cl. CPC H04W 12/06; H04L 9/0841; H04W 12/03; H04W 12/043

(57) ABSTRACT

Mutual authentication ana encryption key generation for secure wireless communication between an implantable medical device and an external device employs asymmetric cryptography. A method of conducting secure wireless communication between an implantable medical device and an external device includes conducting a mutual authentication procedure that employs asymmetric cryptography via wireless communication between the implantable medical device and the external device. A shared encryption key is generated by the external device. The shared encryption key is generated by the implantable medical device. Wireless communication is conducted between the implantable medical device and the external device via wireless transmissions encrypted via the shared encryption key.

### CROSS-REFERENCE TO RELATED APPLICATION

The present application is a Continuation of PCT/US2024/035297 filed Jun. 24, 2024; which claims priority to U.S. Provisional Appln. No. 63/524,565 filed Jun. 30, 2023; the full disclosures which are incorporated herein by reference in their entirety for all purposes.

### BACKGROUND

Many implantable medical devices include a programmable controller that controls operation of the implantable medical device. Examples of implantable medical devices that may include a programmable controller include mechanical circulatory support pumps (e.g., ventricular assist devices), cardioverter defibrillators, pacemakers, and implantable sensors such as blood pressure monitoring sensors. An external control device can be used by a clinician to program/configure and/or read data from an implanted medical device. The external control device and the implanted medical device can be configured to communicate via wireless transmissions.

Bluetooth, Near-Field Communication (NFC), and proprietary radio-frequency (RF) such as OOK RX/TX (On-Off Keying) are prominent wireless technologies used for communicating with implanted medical devices. Device authentication and encryption of wireless transmissions between the external control device and the implanted medical device may be necessary to meet cybersecurity requirements. The standard Bluetooth security functions, however, rely on the user input of a personal identification number (PIN) or passphrase on both peer devices, which cannot be accomplished with an inaccessible implanted medical device. NFC authentication relies on “tapping” or “close contact” of the peer devices, which is not possible with many implanted medical devices. In many other RF technologies, the device authentication and data encryption are either not defined or implemented in an ad-hoc way that may not satisfy cybersecurity requirements.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments disclosed herein are directed to secure wireless communication between an implantable medical device and an external device. In many embodiments, asymmetric cryptography is used for device authentication and a shared encryption key is generated based on the authentication. The methods of conducting secure wireless communication between an implantable medical device and an external device provide for effective and efficient mutual authentication and data encryption.

In one aspect, a method of conducting secure wireless communication between an implantable medical device and an external device employs asymmetric cryptography. The method includes conducting a mutual authentication procedure that employs asymmetric cryptography via wireless communication between the implantable medical device and the external device. A shared encryption key is generated by the external device. The shared encryption key is generated by the implantable medical device. Wireless communication between the implantable medical device and the external device is conducted via wireless transmissions encrypted via the shared encryption key.

In many embodiments of the method, an implantable medical device asymmetric key pair is stored in the implantable medical device and an external device asymmetric key pair is stored in the external device. The implantable medical device asymmetric key pair can include an implantable medical device public key and an implantable medical device private key. The external device asymmetric key pair can include an external device public key and an external device private key. The implantable medical device asymmetric key pair can be stored in the implantable medical device prior to conducting the mutual authentication procedure. The external device asymmetric key pair can be stored in the external device prior to conducting the mutual authentication procedure.

In some embodiments of the method, an implantable medical device X.509 certificate is stored in the implantable medical device and an external device X.509 certificate is stored in the external device. The implantable medical device X.509 certificate can include the implantable medical device public key. The external device X.509 certificate can include the external device public key. In some embodiments of the method, the implantable medical device X.509 certificate is less than 512 bytes in size and the external device X.509 certificate is less than 512 bytes in size. In some embodiments of the method, the implantable medical device X.509 certificate is signed using Elliptical Curve Digital Signature Algorithm (ECDSA) using P-256 or Secure Hash Algorithm 256 (SHA-256) and the external device X.509 certificate is signed using Elliptical Curve Digital Signature Algorithm (ECDSA) using P-256 or Secure Hash Algorithm 256 (SHA-256).

In some embodiments of the method, an implantable medical device authentication token structure is stored in the implantable medical device and an external device authentication token structure is stored in the external device. The implantable medical device authentication token structure can include the implantable medical device public key. The external device authentication token structure can include the external device public key.

In many embodiments of the method, the mutual authentication procedure includes transmitting, by the external device, the external device public key to the implantable medical device and transmitting, by the implantable medical device, the implantable medical device public key to the external device. In many embodiments of the method, the external device public key is verified by the implantable medical device and the implantable medical device public key is verified by the external device. In some embodiments of the method, the implantable medical device uses a Public Key Infrastructure (PKI) certificate to verify the external device public key and the external device uses the PKI certificate to verify the implantable medical device public key.

In some embodiments of the method, the mutual authentication procedure includes verification of the external device private key by the implantable medical device and verification of the implantable medical device private key by the external device. For example, the mutual authentication procedure can include: (1) generating, by the external device, an external device random nonce; (2) transmitting, by the external device, the external device random nonce to the implantable medical device; (3) generating, by the implantable medical device, an implantable medical device random nonce; (4) transmitting, by the implantable medical device, the implantable medical device random nonce to the external device; (5) generating a signed implantable medical device random nonce, by the external device, by signing the implantable medical device random nonce using the external device private key; (6) generating a signed external device random nonce, by the implantable medical device, by signing the external device random nonce using the implantable medical device private key; (7) transmitting, by the external device, the signed implantable medical device random nonce to the implantable medical device; (8) transmitting, by the implantable medical device, the signed external device random nonce to the external device; (9) verifying, by the implantable medical device, the external device private key using the external device public key; and (10) verifying, by the external device, the implantable medical device private key using the implantable medical device public key.

In many embodiments of the method, the shared encryption key is generated using asymmetric cryptography. For example, the external device can generate the shared encryption key using the implantable medical device public key and the external device private key and the implantable medical device can generate the shared encryption key using the external device public key and the implantable medical device private key. In some embodiments of the method, an Elliptic-curve Diffie Hellman (ECDH) algorithm is used to generate the shared encryption key.

Any suitable approach can be used to encrypt the wireless transmissions between the external device and the implantable medical device. For example, in some embodiments of the method, an Advance Encryption Standard (AES) algorithm is used to encrypt the wireless transmissions. In some embodiments of the method, at least some of the wireless transmissions are double encrypted via the shared encryption key and Bluetooth over-the-air (OTA) encryption.

In another aspect, a medical system includes an implantable medical device and an external device. The implantable medical device includes a medical device wireless communication unit and a medical device controller configured to control operation of the medical device and the medical device wireless communication unit. The external device includes an external device wireless communication unit and an external device controller configured to control operation of the external device wireless communication unit. The external device controller and the medical device controller are configured to conduct a mutual authentication procedure that employs asymmetric cryptography via wireless communication between the medical device wireless communication unit and the external device wireless communication unit; generate a shared encryption key by the external device controller; generate the shared encryption key by the medical device controller; and conduct wireless communication between the medical device wireless communication unit and the external device wireless communication unit via wireless transmissions encrypted via the shared encryption key.

In some embodiments of the medical system, a medical device asymmetric key pair is stored in the medical device controller and an external device asymmetric key pair is stored in the external device controller. The medical device asymmetric key pair can include a medical device public key and a medical device private key. The external device asymmetric key pair can include an external device public key and an external device private key. The medical device asymmetric key pair can be stored in the medical device controller prior to conducting the mutual authentication procedure. The external device asymmetric key pair can be stored in the external device controller prior to conducting the mutual authentication procedure.

In some embodiments of the medical system, a medical device X.509 certificate is stored in the medical device controller and an external device X.509 certificate is stored in the external device controller. The medical device X.509 certificate can include the medical device public key. The external device X.509 certificate comprises the external device public key. The medical device X.509 certificate can be less than 512 bytes in size. The external device X.509 certificate can be less than 512 bytes in size. The medical device X.509 certificate can be signed using Elliptical Curve Digital Signature Algorithm (ECDSA) using P-256 or Secure Hash Algorithm 256 (SHA-256). The external device X.509 certificate is signed using Elliptical Curve Digital Signature Algorithm (ECDSA) using P-256 or Secure Hash Algorithm 256 (SHA-256).

In some embodiments of the medical system, a medical device authentication token structure is stored in the medical device controller and an external device authentication token structure is stored in the external device controller. The medical device authentication token structure can include the medical device public key. The external device authentication token structure can include the external device public key.

In some embodiments of the medical system, the mutual authentication procedure includes mutual verification of the public keys. For example, the mutual authentication procedure can include (1) transmitting, by the external device wireless communication unit, the external device public key to the medical device wireless communication unit; (2) transmitting, by the medical device wireless communication unit, the medical device public key to the external device wireless communication unit; (3) verifying, by the medical device controller, the external device public key; and (4) verifying, by the external device controller, the medical device public key. The medical device controller can be configured to verify the external device public key using a Public Key Infrastructure (PKI) certificate. The external device controller can be configured to verify the medical device public key using the PKI certificate.

In some embodiments of the medical system, the mutual authentication procedure includes mutual verification of the private keys. For example, the mutual authentication can include: (1) generating, by the external device controller, an external device random nonce; (2) transmitting, by the external device wireless communication unit, the external device random nonce to the medical device wireless communication unit; (3) generating, by the medical device, a medical device random nonce; (4) transmitting, by the medical device wireless communication unit, the medical device random nonce to the external device wireless communication unit; (5) generating a signed medical device random nonce, by the external device controller, by signing the medical device random nonce using the external device private key; (6) generating a signed external device random nonce, by the medical device controller, by signing the external device random nonce using the medical device private key; (7) transmitting, by the external device wireless communication unit, the signed medical device random nonce to the medical device wireless communication unit; (8) transmitting, by the medical device wireless communication unit, the signed external device random nonce to the external device wireless communication unit; (9) verifying, by the medical device controller, the external device private key using the external device public key; and (10) verifying, by the external device controller, the medical device private key using the medical device public key.

In many embodiments of the medical system, the shared encryption key is generated using asymmetric cryptography. For example, the external device controller can generate the shared encryption key using the medical device public key and the external device private key and the medical device controller can generate the shared encryption key using the external device public key and the medical device private key. An Elliptic-curve Diffie Hellman (ECDH) algorithm can be used to generate the shared encryption key.

Any suitable approach can be used to encrypt the wireless transmissions between the external device and the implantable medical device. For example, in some embodiments of the medical system, an Advance Encryption Standard (AES) algorithm is used to encrypt the wireless transmissions. In some embodiments of the medical system, at least some of the wireless transmissions are double encrypted via the shared encryption key and Bluetooth over-the-air (OTA) encryption.

For a fuller understanding of the nature and advantages of the present invention, reference should be made to the ensuing detailed description and accompanying drawings.

### BRIEF DESCRIPTION OF THE DRAWINGS

FIG. 1 is a simplified schematic illustration of a medical system that includes an implantable medical device and an external device configured for communicating via secure wireless communication, in accordance with embodiments.

FIG. 2 is a simplified schematic illustration of a medical system that includes an implantable ventricular assist device system and an external device configured for communicating via secure wireless communication, in accordance with embodiments.

FIG. 3 is a simplified schematic illustration of a method of conducting secure wireless communication between an implantable medical device and an external device, in accordance with embodiments.

FIG. 4 illustrates a mutual authentication and encryption key generation procedure that employs asymmetric cryptography via Bluetooth Low Energy wireless communication between an implantable medical device and an external device, in accordance with embodiments.

FIG. 5 illustrates a mutual authentication and encryption key generation procedure that employs asymmetric cryptography via proprietary low power radio frequency (RF) wireless communication between an implantable medical device and an external device, in accordance with embodiments.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

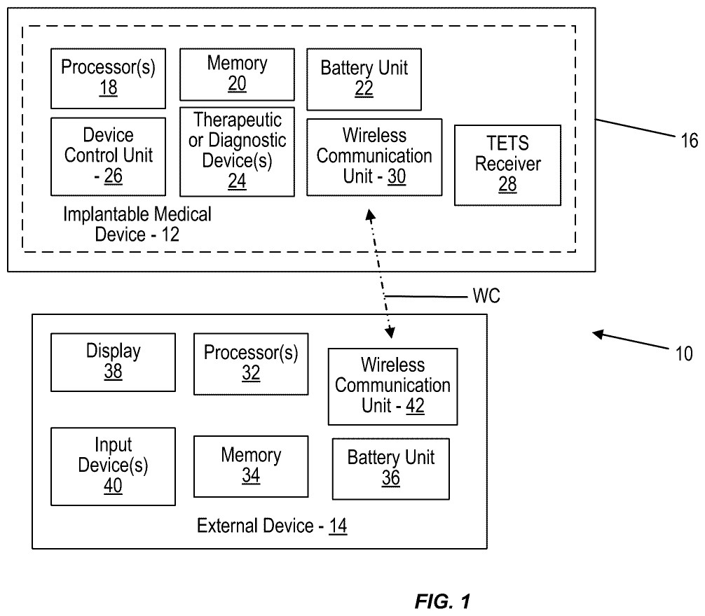

Turning now to the drawing figures in which similar reference identifiers are used to designate similar elements, FIG. 1 is a simplified schematic illustration of a medical system 10 that includes an implantable medical device 12 and an external device 14 configured to communicate via secure wireless communication (WC), in accordance with embodiments. In an implanted state within a patient 16, the medical device 12 is not directly accessible. A mutual authentication and encryption key generation procedure (described herein) that employs asymmetric cryptography and does not require any direct access to the medical device 12 can be used to conduct secure wireless communication (WC) between the medical device 12 and the external device 14. Following completion of mutual device authentication, a shared encryption key is derived by each of the implantable medical device 12 and the external device 14 for use in encrypting wireless transmissions between the implantable medical device 12 and the external device 14.

In the illustrated embodiment, the implantable medical device 12 includes one or more processors 18, a tangible memory device 20, a battery unit 22, one or more therapeutic or diagnostic devices 24, a device control unit 26, a transcutaneous energy transfer system (TETS) receiver 28, and a wireless communication unit 30. The one or more therapeutic or diagnostic devices 24 can include any suitable implantable therapeutic or diagnostic device(s). The device control unit 26 can be configured to control operation of the device(s) 24 under the control of the processor(s) 18. The TETS receiver 28 is configured to receive energy wirelessly transmitted from an externally disposed TETS transmitter (not shown). The energy received by the TETS receiver 28 can be stored in the battery unit 22 and/or used to power operation of the implantable medical device 12. The battery unit 22 is configured to store and supply energy for powering operation of the implantable medical device 12. The memory device 20 can store instructions executable by the processor(s) 18 to cause the processor(s) 18 to control operation of the memory 20, the battery unit 22, the device(s) 24, the device control unit 26, the TETS receiver 28, and/or the wireless communication unit 30. The wireless communication unit 30 can be configured to receive and transmit wireless communications (WC) using any suitable wireless communication technology (e.g., Bluetooth Low Energy wireless communication, proprietary low power radio frequency (RF) wireless communication).

In the illustrated embodiment, the external device 14 includes one or more processors 32, a tangible memory device 34, a battery unit 36, a display 38, one or more input device 40, and a wireless communication unit 42. The external device 14 can be configured for operation by a clinician to conduct encrypted wireless communication (WC) with the implantable medical device 12 (via the wireless communication units 30, 42) to update software and/or data stored on the memory 20 used for controlling operation of the device(s) 24 and/or download data from the memory 20 indicative of measured operational parameters of the device(s) 24 and/or measured physiological parameters of the patient 16. The battery unit 36 is configured to store and supply energy for powering operation of the external device 14. The memory device 34 can store instructions executable by the processor(s) 32 to cause the processor(s) 32 to control operation of the memory 20, the battery unit 22, the display 38, and/or the wireless communication unit 42. The wireless communication unit 42 can be configured to receive and transmit wireless communications (WC) using any suitable wireless communication technology (e.g., Bluetooth Low Energy wireless communication, proprietary low power radio frequency (RF) wireless communication).

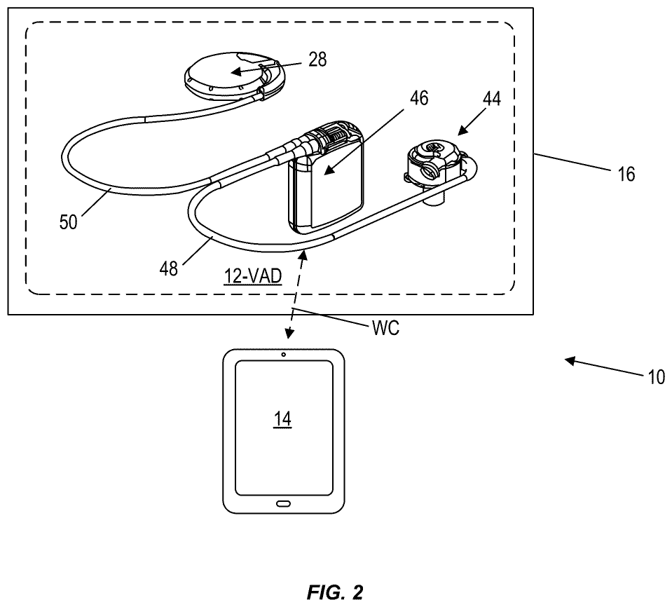

The approaches for conducting secure wireless communications (WC) can be employed with any suitable implantable medical devices, such as, for example, mechanical circulatory support pumps (e.g., ventricular assist devices), cardioverter defibrillators, pacemakers, and implantable sensors such as blood pressure monitoring sensors. For example, FIG. 2 illustrates an embodiment of the medical system 10 in which the implantable medical device 12 includes an implantable ventricular assist device (VAD) system 12-VAD and the external device 14. The VAD system 12-VAD and the external device 14 can be configured for communicating via secure wireless communication (WC) using one of the mutual authentication and encryption key generation procedures described herein. In many embodiments, the external device 14 includes the wireless communication unit 42 (see FIG. 1). The VAD system 12-VAD includes a VAD 44, a VAD controller 46, a TETS receiver 28, a first connection cable 48, and a second connection cable 50. The VAD 44 can be employed as a left ventricular assist device (LVAD) or a right ventricular assist device (RVAD). When employed as an LVAD, the VAD 44 can be implanted with an inlet of the VAD 44 in fluid communication with the left ventricle of a heart and an outlet of the VAD 44 in fluid communication with the ascending aorta and operated to pump blood from the left ventricle to the ascending aorta to supplement pumping of blood by the left ventricle. When employed as an RVAD, the VAD 44 can be implanted with an inlet of the VAD 44 in fluid communication with the right ventricle of a heart and an outlet of the VAD 44 in fluid communication with the pulmonary artery and operated to pump blood from the right ventricle to the pulmonary artery to supplement pumping of blood by the right ventricle. The VAD controller 46 is configured to control operation of the VAD 44 in accordance with a control program stored in the VAD controller 46. The VAD controller 46 can also record operational data for the VAD 44 and/or data indicative of measured physiological parameters of the patient in which the VAD system 12-VAD is implanted. In many embodiments, the VAD controller 46 includes the wireless communication unit 30 (see FIG. 1) for wireless communication (WC) between the VAD controller 46 and the external device 14. The first connection cable 48 connects the VAD controller 46 and the VAD 44. The first connection cable 48 is configured to transfer power and control signals from the VAD controller 46 to the VAD 44 to power and control operation of the VAD 44. The TETS receiver 28 is configured to receive energy transcutaneously transmitted by an external TETS transmitter (not shown) for powering the VAD system 12-VAD. The second connection cable 50 connects the TETS receiver 28 and the VAD controller 46. In many embodiments, the VAD controller 46 includes the battery unit 22 (see FIG. 1) for storing energy for powering the VAD system 12-VAD when energy is not being received by the TETS receiver 28. In many embodiments, the VAD controller 46 includes the wireless communication unit 30 (see FIG. 1). In many embodiments, the mutual authentication and encryption key generation procedure (which employs asymmetric cryptography as described herein) is employed in which a shared encryption key is derived by each of the VAD controller 46 and the external device 14 for use in encrypting wireless transmissions between the wireless communication unit 30 of the VAD controller 46 and the wireless communication unit 42 of the external device 14.

### Mutual Authentication and Encryption Key Generation

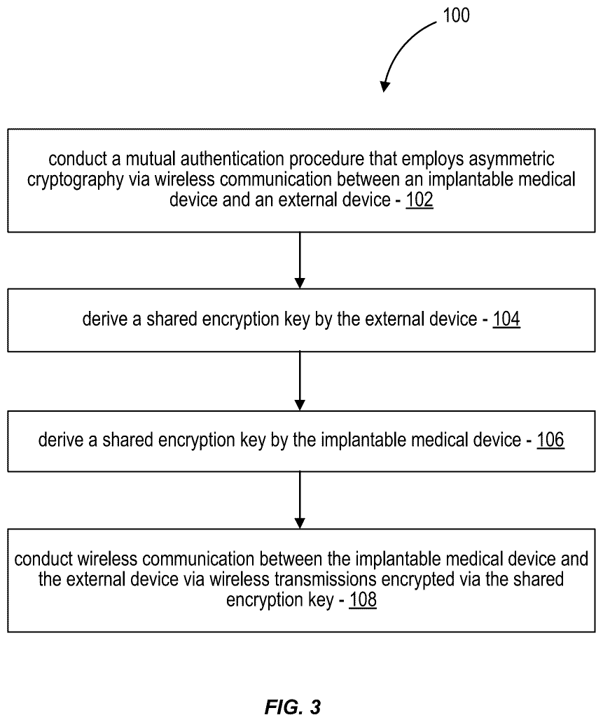

FIG. 3 is a simplified schematic illustration of a method 100 of conducting secure wireless communication between an implantable medical device 12 and an external device 14, in accordance with embodiments. The method 100 can be practiced by any suitable medical system that includes an implantable medical device 12 configured for wireless communication and an external control device configured for wireless communication and for updating and/or transferring data between the implantable medical device 12 and the external control device. For example, the method 100 can be practiced by each of the medical systems 10, 20. In act 102, a mutual authentication procedure is conducted that employs asymmetric cryptography via wireless communication between an implantable medical device 12 and an external device 14. Any suitable mutual authentication procedure that employs asymmetric cryptography via wireless communication between the implantable medical device 12 and the external device 14 can be used to accomplish act 102. In act 104, the external device 14 derives a shared/common encryption key for use in encrypting transmissions between the external device 14 and the implantable medical device 12. In act 106, the implantable medical device 12 generates the shared/common encryption key for use in encrypting transmissions between the external device 14 and the implantable medical device 12. In act 108, wireless communication is conducted between the implantable medical device 12 and the external device 14 via wireless transmissions encrypted via the shared encryption key.

### Bluetooth Low Energy Implementation

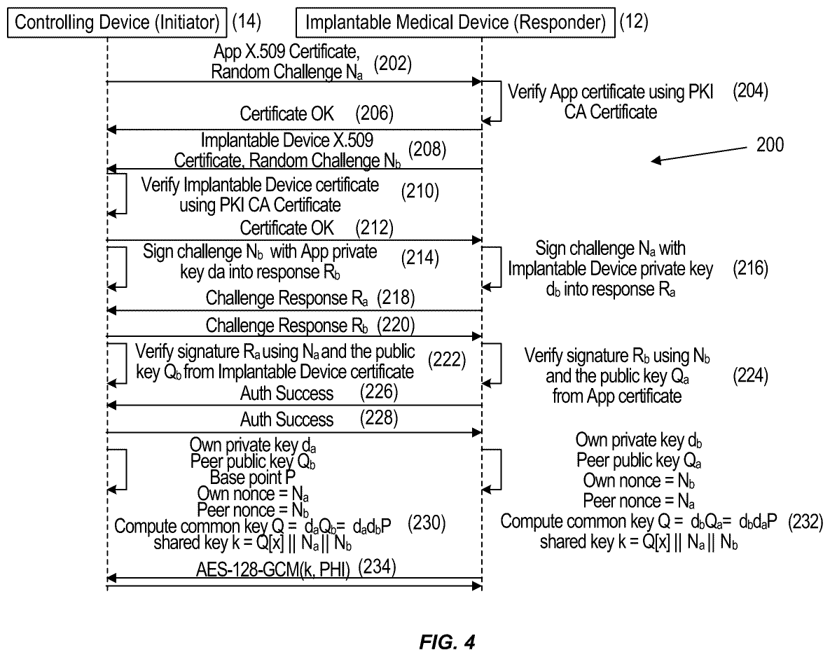

FIG. 4 shows a mutual authentication and key agreement procedure 200 that can be employed in conjunction with Bluetooth Low Energy wireless communication to accomplish the method 100. In many embodiments, the external device 14 stores an asymmetrical key pair for the external device 14 that includes a public key for the external device 14 (“external device public key”) and a private key for the external device 14 (“external device private key”). In embodiments employing Bluetooth Low Energy wireless communication, the external device 14 can store a device certificate for the external device 14 (“external device certificate”). The external device certificate can be issued from the Public Key Infrastructure Certificate Authority (PKA CA) for the manufacturer of the external device 14. The external device public key can be encapsulated within the external device certificate. The external device certificate can be an X.509 certificate. The external device certificate can be signed using a strong asymmetric algorithm such as Elliptical Curve Digital Signature Algorithm using P-256 (ECDSA P-256) or Secure Hash Algorithm 256 (SHA-256) so that the size of the external device certificate is less than 512 bytes for over-the-air wireless transmission of the external device certificate. In many embodiments, the implantable medical device 12 stores an asymmetrical key pair for the implantable medical device 12 that includes a public key for the implantable medical device 12 (“implantable medical device public key”) and a private key for the implantable medical device 12 (“implantable medical device private key”). In embodiments employing Bluetooth Low Energy wireless communication, the implantable medical device 12 can store a device certificate for the implantable medical device 12 (“implantable medical device certificate”). The implantable medical device certificate can be issued from the Public Key Infrastructure Certificate Authority (PKA CA) for the manufacturer of the implantable medical device 12. The implantable medical device public key can be encapsulated within the implantable medical device certificate. The implantable medical device certificate can be an X.509 certificate. The implantable medical device certificate can be signed using a strong asymmetric algorithm such as ECDSA P-256 or SHA-256 so that the size of the implantable medical device certificate is less than 512 bytes for over-the-air wireless transmission of the implantable medical device certificate.

The mutual authentication and key agreement procedure 200 employs asymmetric cryptography via Bluetooth Low Energy wireless communication between the implantable medical device 12 and the external device 14. Mutual authentication is accomplished via act 202 through act 228. Encryption key agreement is accomplished via act 230 and act 232.

In the mutual authentication portion of the procedure 200, each of the devices validates the public key and the private key of the other device. In act 202, the external device 14 generates a random nonce (Nₐ) (“external device random nonce”—random value) and transmits the external device certificate and the external device random nonce (Nₐ) to the implantable medical device 12. In act 204, the implantable medical device 12 uses upper level key (PKI CA public key) in the key chain to validate the external device public key. In response to validating the external device public key, the implantable medical device 12 transmits an external device public key confirmation message to the external device 14 in act 206. In act 208, the implantable medical device 12 generates a random nonce (N_{b}) (“implantable medical device random nonce”—random value) and transmits the implantable medical device certificate and the implantable medical device random nonce (N_{b}) to the external device 14. In act 210, the external device 14 uses upper level key (PKI CA public key) in the key chain to validate the implantable medical device public key. In response to validating the implantable medical device public key, the external device 14 transmits an implantable medical device public key confirmation message to the implantable medical device 12 in act 212. In act 214, the external device 14 generates a response (Rb) by signing the implantable medical device nonce (N_{b}) with the external device private key. In act 216, the implantable medical device 12 generates a response (Rₐ) by signing the external device nonce (Nₐ) with the implantable medical device private key. In act 218, the implantable medical device 12 transmits the response (Rₐ) to the external device 14. In act 220, the external device 14 transmits the response (R_{b}) to the implantable medical device 12. In act 222, the external device 14 uses the implantable medical device public key to verify that the response (Rₐ) indicates that the implantable medical device 12 possesses the right private key. In act 224, the implantable medical device 12 uses the external device public key to verify that the response (R_{b}) indicates that the external device 14 possesses the right private key. In act 226, the implantable medical device 12 transmits an authentication success message to the external device 14. In act 228, the external device 14 transmits an authentication success message to the implantable medical device 12.

When the mutual authentication portion of the procedure 200 is completed, the external device 14 and the implantable medical device 12 can proceed directly with encrypting transmissions using the existing Bluetooth standard, which includes a Diffie-Hellman key exchange and support over-the-air (OTA) encryption. If double encryption is desired (e.g., Bluetooth OTA encryption at link layer and application layer encryption using the key agreement portion of the procedure 200) act 230 and act 232 can be accomplished by the external device 14 and the implantable medical device 12, respectively, to compute a shared key (k) used for the application layer encryption. In act 230, the external device 14 computes the shared key (k) using equation (1) and equation (2) with the external device private key (dₐ), the implantable medical device public key (Q_{b}), the base point (P), the external device nonce (Nₐ), and the implantable medical device nonce (N_{b}) as inputs. The base point (P) (represented by its (x, y) coordinates on the elliptic curve) is used to generate all other points on the curve through point scalar multiplication. Note that the point scalar multiplication is implemented as successively adding a point along the elliptic curve to itself repeatedly.

$$common key Q = {d}_{a} {Q}_{b} = {d}_{a} {d}_{b} P \qquad equation ( 1 )$$

$$shared key k = Q \vert \vert {N}_{a} \vert \vert {N}_{b} \qquad equation ( 2 )$$

In act 232, the implantable medical device 12 computes the shared key (k) using equation (3) and equation (4) with the implantable medical device private key (d_{b}), the external device public key (Qₐ), the base point (P), the implantable device nonce (N_{b}), and the external device nonce (Nₐ) as inputs.

$$common key Q = {d}_{b} {Q}_{a} = {d}_{b} {d}_{a} P \qquad equation ( 3 )$$

$$shared key k = Q \vert \vert {N}_{a} \vert \vert {N}_{b} \qquad equation ( 4 )$$

In act 234, the external device 14 and the implantable medical device 12 exchange encrypted transmissions using Bluetooth Low Energy wireless communication. In the illustrated embodiment, the transmissions are encrypted using the Advanced Encryption Standard using Galois Counter Mode with block size 128 bits (AES-128-CGM(k, PHI)).

### Proprietary Low Power Wireless Implementation

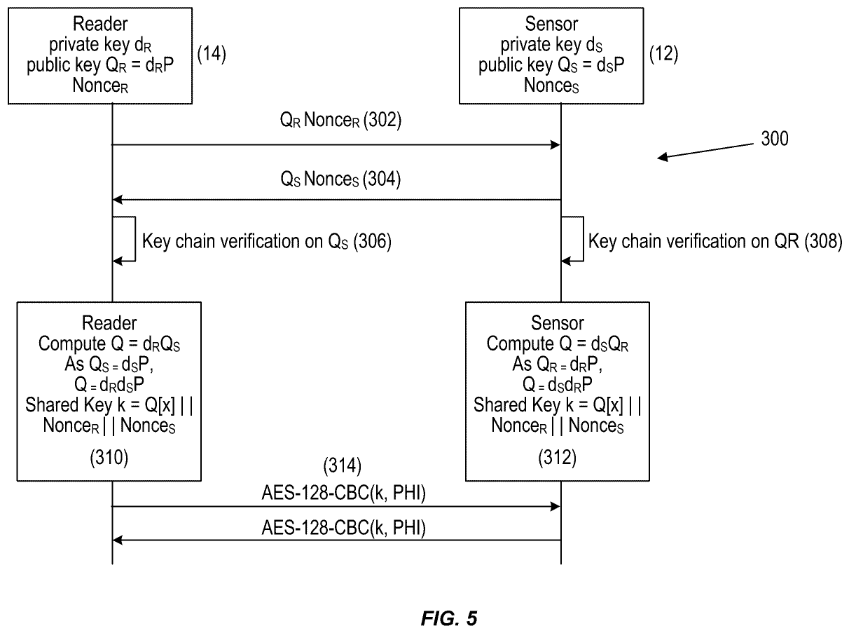

FIG. 5 shows a mutual authentication and key agreement procedure 300 that can be employed in conjunction with proprietary low power wireless (e.g., on-off keying (OOK)) based devices to accomplish the method 100. Proprietary low power wireless technology (such as OOK RX/TX) typically can employ an RF charge phase to supply power to an implantable medical device 12 (e.g., a sensor) via RF signals emitted from an external device 14. Following the RF charge phase, the mutual authentication and key agreement procedure 300 can be accomplished to authenticate the devices and derive a shared key for OTA encryption through the session. A different encryption key is derived for each session due to the use the nonces in key agreement. Each of the external device public key and the implantable medical device public key can be embedded in a respective authentication token structure to further reduce the size of the over-the-air data exchanged during the mutual authentication procedure 300. The external device or reader 14 stores an asymmetrical key pair for the external device 14 that includes a public key (Q_{R}) for the external device 14 (“external device public key”) and a private key (d_{R}) for the external device 14 (“external device private key”). The implantable medical device or sensor 12 stores an asymmetrical key pair for the implantable medical device 12 that includes a public key (Q_{S}) for the implantable medical device 12 (“implantable medical device public key”) and a private key (d_{S}) for the implantable medical device 12 (“implantable medical device private key”).

The mutual authentication and key agreement procedure 300 employs asymmetric cryptography via proprietary low power wireless communication between the implantable medical device 12 and the external device 14. Mutual authentication is accomplished via act 202 through act 228. Encryption key agreement is accomplished via act 230 and act 232.

In the mutual authentication portion of the procedure 300, each of the external device 14 and the implantable medical device 12 validates the public key and the private key of the other device. In act 302, the external device 14 transmits the external device public key (Q_{R}) and an external device nonce (Nonce_{R}) (generated by the external device 14) to the implantable medical device 12. In act 304, the implantable medical device 12 transmits the implantable medical device public key (Q_{S}) and an implantable medical device nonce (Nonces) (generated by the implantable medical device 12) to the external device 14. In act 306, the external device 14 performs key chain verification of the implantable medical device public key (Q_{S}). Any suitable approach can be used to perform the key chain modification of the implantable medical device public key (Q_{S}) including the approach described herein with regard to acts 210, 212 of the procedure 200.

In act 308, the implantable medical device 12 performs key chain verification of the external device public key (Q_{R}). Any suitable approach can be used to perform the key chain modification of the external device public key (Q_{R}) including the approach described herein with regard to acts 204, 206 of the procedure 200.

When the mutual authentication portion of the procedure 300 is completed, each of the external device 14 and the implantable medical device 12 compute a shared encryption key (k) using asymmetric cryptography. In act 310, the external device 14 computes the shared key (k) using equation (5) and equation (6) with the external device private key (d_{R}), the implantable medical device public key (Q_{S}), the base point (P), the external device nonce (Nonce_{R}), and the implantable medical device nonce (Nonces) as inputs.

$$common key Q = {d}_{R} {Q}_{S} = {d}_{R} {d}_{S} P \qquad equation ( 5 )$$

$$shared key k = Q \vert \vert {Nonce}_{R} \vert \vert {Nonce}_{S} \qquad equation ( 6 )$$

In act 312, the implantable medical device 12 computes the shared key (k) using equation (7) and equation (8) with the implantable medical device private key (d_{S}), the external device public key (Q_{R}), the base point (P), the implantable device nonce (Nonces), and the external device nonce (Nonce_{R}) as inputs.

$$common key Q = {d}_{R} {Q}_{a} = {d}_{S} {d}_{R} P \qquad equation ( 7 )$$

$$shared key k = Q \vert \vert {Nonce}_{R} \vert \vert {Nonce}_{S} \qquad equation ( 8 )$$

In act 314, the external device 14 and the implantable device exchange encrypted transmissions using proprietary low power wireless communication. In the illustrated embodiment, the transmissions are encrypted using the Advanced Encryption Standard using Galois Counter Mode with block size 128 bits (AES-128-CGM(k, PHI)).

### Example Mutual Authentication and Key Agreement Procedure Implementation

This section provides an example implementation of the mutual authentication and key agreement procedure 200 illustrated in FIG. 4.

### PKI Hierarchy

The PKI CA key pair and certificate constitute the root of the trust.

```
[ca-private-key.pem]
-----BEGIN EC PRIVATE KEY-----
MHcCAQEEINCDQCjKXYefQNdYIDa1M989T8/YxQu+YmA7j3gToRrLoAoGCCqGSM49
AwEHoUQDQgAE9nj25xzi+tHqbgKRaspygBPgbT+jpFT6Sm4BWdCyN+tGRiR/MhYp
oAaltVplzcldUzcM9OGJnvetyOGeo5Xn4g==
-----END EC PRIVATE KEY-----
[ca-public-key.pem]
-----BEGIN PUBLIC KEY-----
MFkwEwYHKoZIzj0CAQYIKoZIzj0DAQcDQgAE9nj25xzi+tHqbgKRaspygBPgbT+j
pFT6Sm4BWdCyN+tGRiR/MhYpoAaltVplzcldUzcM9OGJnvetyOGeo5Xn4g==
-----END PUBLIC KEY-----
[ca-certificate.pem]
Certificate:
  Data:
    Version: 3 (0x2)
    Serial Number:
      70:c3:2a:ef:a7:23:be:46:7c:dc:80:03:41:e7:0a:cb:9d:5d:6f:b2
    Signature Algorithm: ecdsa-with-SHA256
    Issuer: C = US, ST = IL, L = Abbott Park, O = Abbott, CN = Certification
Authority
    Validity
      Not Before: Apr 26 22:24:11 2023 GMT
      Not After : Apr 23 22:24:11 2033 GMT
    Subject: C = US, ST = IL, L = Abbott Park, O = Abbott, CN = Certification
Authority
    Subject Public Key Info:
      Public Key Algorithm: id-ecPublicKey
        Public-Key: (256 bit)
        pub:
          04:f6:78:f6:e7:1c:e2:fa:d1:ea:6e:02:91:6a:ca:
          72:80:13:e0:6d:3f:a3:a4:54:fa:4a:6e:01:59:d0:
          b2:37:eb:46:46:24:7f:32:16:29:a0:06:a5:b5:5a:
          65:cd:c9:5d:53:37:0c:f4:e1:89:9e:f7:ad:c8:e1:
          9e:a3:95:e7:e2
        ASN1 OID: prime256v1
        NIST CURVE: P-256
    X509v3 extensions:
      X509v3 Subject Key Identifier:
        5E:2A:19:FB:B3:55:CF:B1:EB:FB:6E:B0:BF:FB:F0:CE:D0:F7:ED:10
      X509v3 Authority Key Identifier:
        5E:2A:19:FB:B3:55:CF:B1:EB:FB:6E:B0:BF:FB:F0:CE:D0:F7:ED:10
      X509v3 Basic Constraints: critical
        CA:TRUE
      X509v3 Key Usage:
        Digital Signature, Non Repudiation, Key Agreement, Certificate
Sign, CRL Sign
  Signature Algorithm: ecdsa-with-SHA256
  Signature Value:
    30:46:02:21:00:a8:b1:62:7b:29:2d:7d:81:d8:69:80:c7:81:
    52:99:2b:77:a5:48:ad:11:4b:6a:43:39:19:1a:da:bf:ad:ca:
    8f:02:21:00:8b:60:50:8c:be:1d:93:e2:29:00:d3:e2:e3:4a:
    d2:56:84:86:5e:1e:5a:82:2e:84:7c:e1:3f:ba:d4:e4:e5:af
```

The Initiator key pair is generated and used to create a certificate signing request. The Initiator certificate signing request is signed into a certificate using the CA's private key.

```
[initiator-private-key.pem]
-----BEGIN EC PRIVATE KEY-----
MHcCAQEEIO7WjWXfWFFAYRtydir2HH4TmymGdtrJxVCH/m3jT1aOoAoGCCqGSM49
AwEHoUQDQgAE8INpOJIClogmmGZDQGVASa2LiNaNY1E6G94WJlEiaXddnfv3fJca
41VqNwpc5gw2x1ADjpp7btSzR0qft0sFTQ==
-----END EC PRIVATE KEY-----
[initiator-public-key.pem]
-----BEGIN PUBLIC KEY-----
MFkwEwYHKoZIzj0CAQYIKoZIzj0DAQcDQgAE8INpOJIClogmmGZDQGVASa2LiNaN
Y1E6G94WJlEiaXddnfv3fJca41VqNwpc5gw2x1ADjpp7btSzR0qft0sFTQ==
-----END PUBLIC KEY-----
[initiator-certificate.pem]
Certificate:
  Data:
    Version: 3 (0x2)
    Serial Number:
      19:2c:97:90:ec:85:89:56:bd:de:6b:ca:e9:c9:4e:be:04:69:ba:98
    Signature Algorithm: ecdsa-with-SHA256
    Issuer: C = US, ST = IL, L = Abbott Park, O = Abbott, CN = Certification
Authority
    Validity
      Not Before: Apr 26 22:53:13 2023 GMT
      Not After : Apr 25 22: 53:13 2025 GMT
    Subject: C = US, ST = IL, L = Abbott Park, O = Abbott, CN = Initiator
    Subject Public Key Info:
      Public Key Algorithm: id-ecPublicKey
        Public-Key: (256 bit)
        pub:
          04:f0:83:69:38:92:02:96:88:26:98:66:43:40:65:
          40:49:ad:8b:88:d6:8d:63:51:3a:1b:de:16:26:51:
          22:69:77:5d:9d:fb:f7:7c:97:1a:e3:55:6a:37:0a:
          5c:e6:0c:36:c7:50:03:8e:9a:7b:6e:d4:b3:47:4a:
          9f:b7:4b:05:4d
        ASN1 OID: prime256v1
        NIST CURVE: P-256
    X509v3 extensions:
      X509v3 Authority Key Identifier:
        5E:2A:19:FB:B3:55:CF:B1:EB:FB:6E:B0:BF:FB:F0:CE:D0:F7:ED:10
      X509v3 Basic Constraints:
        CA:FALSE
      X509v3 Key Usage:
        Digital Signature, Key Agreement
      X509v3 Extended Key Usage:
        TLS Web Server Authentication, TLS Web Client Authentication
      X509v3 Subject Key Identifier:
        99:BA:DF:D0:E1:A1:95:67:D5:83:C2:25:58:49:80:1D:7B:D0:FA:6B
  Signature Algorithm: ecdsa-with-SHA256
  Signature Value:
    30:45:02:20:2c:8e:de:af:95:d8:cf:dc:20:17:e7:7f:ec:99:
    a8:12:99:e4:d7:b0:82:54:28:24:86:fc:f4:c5:28:73:de:38:
    02:21:00:a2:db:ff:98:48:0d:83:bd:42:da:b9:bb:f2:44:23:
    19:d9:b2:cd:e8:47:75:30:b5:80:21:9f:5d:da:7f:08:68
```

The Responder key pair is generated and used to create a certificate signing request. The Responder certificate signing request is signed into a certificate using the CA's private key.

```
[responder-private-key.pem]
-----BEGIN EC PRIVATE KEY-----
MHcCAQEEIKFax3DlC96Sg4g/l+hFHh9YCffUPM7ZnqcJGVYCAWWKoAoGCCqGSM49
AwEHoUQDQgAEE8XsIegfceOyGXhsF43At7G1i+GpjxPQJocBx1lTpA7pjCn6W13F
FWU6G+np/7H/XrI8HIA4bUobvNQlPSxx6A==
-----END EC PRIVATE KEY-----
[responder-public-key.pem]
-----BEGIN PUBLIC KEY-----
MFkwEwYHKoZIzj0CAQYIKoZIzj0DAQcDQgAEE8XsIegfceOyGXhsF43At7G1i+Gp
jxPQJocBx1lTpA7pjCn6W13FFWU6G+np/7H/XrI8HIA4bUobvNQlPSxx6A==
-----END PUBLIC KEY-----
[responder-certificate.pem]
Certificate:
  Data:
    Version: 3 (0x2)
    Serial Number:
      13:a5:9d:e4:13:8c:c8:ee:8d:40:fd:aa:58:92:af:d1:b3:74:96:70
    Signature Algorithm: ecdsa-with-SHA256
    Issuer: C = US, ST = IL, L = Abbott Park, O = Abbott, CN = Certification
Authority
    Validity
      Not Before: Apr 26 22:54:34 2023 GMT
      Not After : Apr 25 22:54:34 2025 GMT
    Subject: C = US, ST = IL, L = Abbott Park, O = Abbott, CN = Responder
    Subject Public Key Info:
      Public Key Algorithm: id-ecPublicKey
        Public-Key: (256 bit)
        pub:
          04:13:c5:ec:21:e8:1f:71:e3:b2:19:78:6c:17:8d:
          c0:b7:b1:b5:8b:e1:a9:8f:13:d0:26:87:01:c7:59:
          53:a4:0e:e9:8c:29:fa:5b:5d:c5:15:65:3a:1b:e9:
          e9:ff:b1:ff:5e:b2:3c:1c:80:38:6d:4a:1b:bc:d4:
          25:3d:2c:71:e8
        ASN1 OID: prime256v1
        NIST CURVE: P-256
    X509v3 extensions:
      X509v3 Authority Key Identifier:
        5E:2A:19:FB:B3:55:CF:B1:EB:FB:6E:B0:BF:FB:F0:CE:D0:F7:ED:10
      X509v3 Basic Constraints:
        CA:FALSE
      X509v3 Key Usage:
        Digital Signature, Key Agreement
      X509v3 Extended Key Usage:
        TLS Web Server Authentication, TLS Web Client Authentication
      X509v3 Subject Key Identifier:
        51:A2:41:EF:3D:48:36:1E:34:32:2A:64:09:1C:DE:5D:D8:84:9C:4B
  Signature Algorithm: ecdsa-with-SHA256
  Signature Value:
    30:45:02:20:2d:af:68:fa:b0:70:f5:36:02:12:63:1e:3c:cc:
    f1:a8:2f:c7:cd:8c:2b:05:b5:a4:22:65:64:7a:b3:7c:17:24:
    02:21:00:c2:56:da:11:83:cc:88:72:d5:76:65:11:35:40:27:
    28:0b:cf:f9:0f:01:64:be:32:5b:ab:0e:19:95:66:0d:c2
```

### Wireless Secure Pairing

The first phase of the security pairing is the exchange of device certificates and challenge random nonce to kick off mutual authentication. The Initiator sends its certificate [initiator-certificate.pem] and a randomly generated challenge nonce Nₐ to the Responder.

openssl rand -base64 16 > na-value.txt
[na-value.txt]
1xVcPXfEFhmHuAw89f+/Rw==
Nₐ = Base64(1xVcPXfEFhmHuAw89f+/Rw==)

The Responder sends its certificate [Responder-certificate.pem] and a randomly generated challenge nonce N_{b} to the Initiator.

openssl rand -base64 16 > nb-value.txt
[nb-value.txt]
G5mXcjM8qz9fM8GLEJlDYw==
N_{b} = Base64(G5mXcjM8qz9fM8GlEJlDYw==)

The Initiator validates the received Responder certificate using the CA certificate.
openssl verify -verbose -CAfile ca-certificate.pem responder-certificate.pem responder-certificate.pem: OK

The Responder validates the received Initiator certificate using the CA certificate.
openssl verify -verbose -CAfile ca-certificate.pem initiator-certificate.pem initiator-certificate.pem: OK

The second phase of the security pairing is the challenge nonce signature check to finish off mutual authentication. This step proves the possession of the private key on both sides. The Responder signs the Nₐ into a challenge response Rₐ using its private key [responder-private-key.pem], then sends the Rₐ to the Initiator.

openssl dgst -sha256 -sign responder-private-key.pem -out na-signature.bin na-
value.txt
Base64(na-signature.bin) =
MEUCIQDL2uj7IkYo8VF3vpBO0++954jxbWRCf1dPiNQ7IKLlwQIgXIbtADou/dSM86dRkUPHvEbv5lzsp
T6B3V5ssxrGMgA=
Rₐ =
Base64(MEUCIQDL2uj7IkYo8VF3vpBO0++954jxbWRCf1dPiNQ7IKLlwQIgXIbtADou/dSM86dRkUPHvE
bv5lzspT6B3V5ssxrGMgA=)

The Initiator signs the N_{b} into a challenge response R_{b} using its private key [initiator-private-key.pem], then sends the R_{b} to the Responder.

openssl dgst -sha256 -sign initiator-private-key.pem -out nb-signature.bin nb-
value.txt
Base64(nb-signature.bin) =
MEUCIBe70BkMsFUkt/uT/T6WFLEIg9f7spCLEg+su23gUZ2aAiEAtekQ0UE4rMKC2K1g8JupoGk+t0ZPQ
J0DnepSNKzR4k4=
R_{b} =
Base64(MEUCIBe70BkMsFUkt/uT/T6WFLEIg9f7spCLEg+su23gUZ2aAiEAtekQ0UE4rMKC2K1g8JupoG
k+t0ZPQJ0DnepSNKzR4k4=)

The Initiator validates the received Rₐ using its Nₐ and the Responder public key [responder-public-key.pem] extracted from the Responder certificate.

openssl dgst -sha256 -verify responder-public-key.pem
-signature na-signature.bin
na-value.txt
Verified OK

The Responder validates the received R_{b} using its N_{b} and the Initiator public key [initiator-public-key.pem] extracted from the initiator certificate.

openssl dgst -sha256 -verify initiator-public-key.pem
-signature nb-signature.bin
nb-value.txt
Verified OK

In the third phase, the Initiator and the Responder perform ECDH independently to generate a common key Q, which is used to generate a shared encryption key k.

Initiator:
openssl pkeyutl -derive -inkey initiator-private-key.pem
-peerkey responder-
public-key.pem -out initiator-secret.bin
Q = Binary(initiator-secret.bin)
Responder:
openssl pkeyutl -derive -inkey responder-private-key.pem
-peerkey initiator-
public-key.pem -out responder-secret.bin
Q = Binary(responder-secret.bin)

The Initiator and the Responder now have the same common key Q to derive the shared encryption key for over-the-air encryption.

```
k = Q || Nₐ || N_{b}
  = Base64(responder-secret.bin) || Base64(na-value.txt) || Base64(nb-value.txt)
  = fC1+AwoFaonZQTLobgqfcX70ctMn0DLmtsu481dgdgs=1xVcPXfEFhmHuAw89f+/Rw==
G5mXcjM8qz9fM8GlEJlDYw==
```

Note that the resulting k is long enough to support many standard encryption algorithms. It can be trimmed to fit a specific algorithm.

The proposed protocol provides similar security strength when comparing with TLS 1.3 (see URL www.rfc-editor.org/rfc/rfc8446.html) and IKEv2 (see URL www.rfc-editor.org/rfc/rfc4754). Per TLS 1.3 specification, the CertificateVerify message contains a signature over the entire handshake using the private key corresponding to the public key in the Certificate message. With IKEv2 IKE_AUTH, the peers are authenticated by having each sign a block of data that includes a message, a nonce and peer identity. In the proposed protocol, the signature is generated on a random challenge nonce instead of the entire handshake transcript or the complete message. This simplified approach is appropriate to reduce the computation resource consumption for low-powered short range wireless devices.

### Non-Limiting Example Embodiments

Example 1 is a method of conducting secure wireless communication between an implantable medical device and an external device. Example 1 includes: (a) conducting a mutual authentication procedure that employs asymmetric cryptography via wireless communication between the implantable medical device and the external device; (b) generating a shared encryption key by the external device; (c) generating the shared encryption key by the implantable medical device; and (d) conducting wireless communication between the implantable medical device and the external device via wireless transmissions encrypted via the shared encryption key. Example 2 is a method in accordance with the example 1, wherein: (a) an implantable medical device asymmetric key pair is stored in the implantable medical device; (b) the implantable medical device asymmetric key pair comprises an implantable medical device public key and an implantable medical device private key; (c) an external device asymmetric key pair is stored in the external device; and (d) the external device asymmetric key pair comprises an external device public key and an external device private key. Example 3 is a method in accordance with the example 2, wherein: (a) the implantable medical device asymmetric key pair is stored in the implantable medical device prior to conducting the mutual authentication procedure; and (b) the external device asymmetric key pair is stored in the external device prior to conducting the mutual authentication procedure. Example 4 is a method in accordance with the example 2, wherein: (a) an implantable medical device X.509 certificate is stored in the implantable medical device; (b) the implantable medical device X.509 certificate comprises the implantable medical device public key; (c) an external device X.509 certificate is stored in the external device; and (d) the external device X.509 certificate comprises the external device public key. Example 5 is a method in accordance with the example 4, wherein: (a) the implantable medical device X.509 certificate is less than 512 bytes in size; and (b) the external device X.509 certificate is less than 512 bytes in size. Example 6 is a method in accordance with the example 5, wherein: (a) the implantable medical device X.509 certificate is signed using Elliptical Curve Digital Signature Algorithm (ECDSA) using P-256 or Secure Hash Algorithm 256 (SHA-256); and (b) the external device X.509 certificate is signed using Elliptical Curve Digital Signature Algorithm (ECDSA) using P-256 or Secure Hash Algorithm 256 (SHA-256). Example 7 is a method in accordance with the example 2, wherein: (a) an implantable medical device authentication token structure is stored in the implantable medical device; (b) the implantable medical device authentication token structure comprises the implantable medical device public key; (c) an external device authentication token structure is stored in the external device; and (d) the external device authentication token structure comprises the external device public key.

Example 8 is a method in accordance with any one of example 2 through example 7, wherein the mutual authentication procedure comprises: (a) transmitting, by the external device, the external device public key to the implantable medical device; (b) transmitting, by the implantable medical device, the implantable medical device public key to the external device; (c) verifying, by the implantable medical device, the external device public key; and (d) verifying, by the external device, the implantable medical device public key. Example 9 is a method in accordance with example 8, wherein: (a) verifying, by the implantable medical device, the external device public key comprises using a Public Key Infrastructure (PKI) certificate; and (b) verifying, by the external device, the implantable medical device public key comprises using the PKI certificate.

Example 10 is a method in accordance with example 8, wherein the mutual authentication procedure further comprises: (a) generating, by the external device, an external device random nonce; (b) transmitting, by the external device, the external device random nonce to the implantable medical device; (c) generating, by the implantable medical device, an implantable medical device random nonce; (d) transmitting, by the implantable medical device, the implantable medical device random nonce to the external device; (e) generating a signed implantable medical device random nonce, by the external device, by signing the implantable medical device random nonce using the external device private key; (f) generating a signed external device random nonce, by the implantable medical device, by signing the external device random nonce using the implantable medical device private key; transmitting, by the external device, the signed implantable medical device random nonce to the implantable medical device; (g) transmitting, by the implantable medical device, the signed external device random nonce to the external device; (h) verifying, by the implantable medical device, the external device private key using the external device public key; and (i) verifying, by the external device, the implantable medical device private key using the implantable medical device public key.

Example 11 is a method in accordance with any one of example 2 through example 7, wherein: (a) the external device generates the shared encryption key using the implantable medical device public key and the external device private key; and (b) the implantable medical device generates the shared encryption key using the external device public key and the implantable medical device private key. Example 12 is a method in accordance with example 11, wherein an Elliptic-curve Diffie Hellman (ECDH) algorithm is used to generate the shared encryption key. Example 13 is a method in accordance with example 12, wherein an Advance Encryption Standard (AES) algorithm is used to encrypt the wireless transmissions. Example 14 is a method in accordance with example 11, wherein at least some of the wireless transmissions are double encrypted via the shared encryption key and Bluetooth over-the-air (OTA) encryption.

Example 15 is a medical system that includes: (a) an implantable medical device comprising a medical device wireless communication unit and a medical device controller configured to control operation of the implantable medical device and the medical device wireless communication unit; and (b) an external device comprising an external device wireless communication unit and an external device controller configured to control operation of the external device wireless communication unit. In example 15, the external device controller and the medical device controller are configured to: (a) conduct a mutual authentication procedure that employs asymmetric cryptography via wireless communication between the medical device wireless communication unit and the external device wireless communication unit; (b) generate a shared encryption key by the external device controller; (c) generate the shared encryption key by the medical device controller; and (d) conduct wireless communication between the medical device wireless communication unit and the external device wireless communication unit via wireless transmissions encrypted via the shared encryption key. Example 16 is a medical system in accordance with example 15, wherein: (a) a medical device asymmetric key pair is stored in the medical device controller; (b) the medical device asymmetric key pair comprises a medical device public key and a medical device private key; (c) an external device asymmetric key pair is stored in the external device controller; and (d) the external device asymmetric key pair comprises an external device public key and an external device private key. Example 17 is a medical system in accordance with example 16, wherein: (a) the medical device asymmetric key pair is stored in the medical device controller prior to conducting the mutual authentication procedure; and (b) the external device asymmetric key pair is stored in the external device controller prior to conducting the mutual authentication procedure. Example 18 is a medical system in accordance with example 16, wherein: (a) a medical device X.509 certificate is stored in the medical device controller; (b) the medical device X.509 certificate comprises the medical device public key; (c) an external device X.509 certificate is stored in the external device controller; and (d) the external device X.509 certificate comprises the external device public key. Example 19 is a medical system in accordance with example 18, wherein: (a) the medical device X.509 certificate is less than 512 bytes in size; and (b) the external device X.509 certificate is less than 512 bytes in size. Example 20 is a medical system in accordance with example 18, wherein: (a) the medical device X.509 certificate is signed using Elliptical Curve Digital Signature Algorithm (ECDSA) using P-256 or Secure Hash Algorithm 256 (SHA-256); and (b) the external device X.509 certificate is signed using Elliptical Curve Digital Signature Algorithm (ECDSA) using P-256 or Secure Hash Algorithm 256 (SHA-256). Example 21 is a medical system in accordance with example 16, wherein: (a) a medical device authentication token structure is stored in the medical device controller; (b) the medical device authentication token structure comprises the medical device public key; (c) an external device authentication token structure is stored in the external device controller; and (d) the external device authentication token structure comprises the external device public key.

Example 22 is a medical system in accordance with any one of example 16 through example 21, wherein the mutual authentication procedure comprises: (a) transmitting, by the external device wireless communication unit, the external device public key to the medical device wireless communication unit; (b) transmitting, by the medical device wireless communication unit, the medical device public key to the external device wireless communication unit; (c) verifying, by the medical device controller, the external device public key; and (d) verifying, by the external device controller, the medical device public key. Example 23 is a medical system in accordance with example 22, wherein: (a) the medical device controller is configured to verify the external device public key using a Public Key Infrastructure (PKI) certificate; and (b) the external device controller is configured to verify the medical device public key using the PKI certificate. Example 24 is a medical system in accordance with example 22, wherein the mutual authentication procedure further comprises: (a) generating, by the external device controller, an external device random nonce; (b) transmitting, by the external device wireless communication unit, the external device random nonce to the medical device wireless communication unit; (c) generating, by the implantable medical device, a medical device random nonce; (d) transmitting, by the medical device wireless communication unit, the medical device random nonce to the external device wireless communication unit; (e) generating a signed medical device random nonce, by the external device controller, by signing the medical device random nonce using the external device private key; (f) generating a signed external device random nonce, by the medical device controller, by signing the external device random nonce using the medical device private key; (g) transmitting, by the external device wireless communication unit, the signed medical device random nonce to the medical device wireless communication unit; (h) transmitting, by the medical device wireless communication unit, the signed external device random nonce to the external device wireless communication unit; (i) verifying, by the medical device controller, the external device private key using the external device public key; and (j) verifying, by the external device controller, the medical device private key using the medical device public key.

Example 25 is a medical system in accordance with any one of example 16 through example 21, wherein: (a) the external device controller generates the shared encryption key using the medical device public key and the external device private key; and (b) the medical device controller generates the shared encryption key using the external device public key and the medical device private key. Example 26 is a medical system in accordance with example 25, wherein an Elliptic-curve Diffie Hellman (ECDH) algorithm is used to generate the shared encryption key. Example 27 is a medical system in accordance with example 26, wherein an Advance Encryption Standard (AES) algorithm is used to encrypt the wireless transmissions. Example 28 is a medical system in accordance with example 25, wherein at least some of the wireless transmissions are double encrypted by via the shared encryption key and Bluetooth over-the-air (OTA) encryption.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

1. A method of conducting secure wireless communication between an implantable medical device and an external device, the method comprising:
conducting a mutual authentication procedure that employs asymmetric cryptography via wireless communication between the implantable medical device and the external device, wherein the mutual authentication procedure comprises:
wirelessly transmitting an external device public key by the external device to the implantable medical device;
validating the external device public key by the implantable medical device;
in response to validating the external device public key by the implantable medical device, transmitting an external device public key confirmation message by the implantable medical device to the external device;
wirelessly transmitting an implantable medical device public key by the implantable medical device to the external device;
validating the implantable medical device public key by the external device; and
in response to validating the implantable medical device public key by the external device, transmitting an implantable medical device public key confirmation message by the external device to the implantable medical device;
generating a shared encryption key by the external device;
generating the shared encryption key by the implantable medical device; and
conducting wireless communication between the implantable medical device and the external device via wireless transmissions encrypted via the shared encryption key.

2. The method of claim 1, wherein:
an implantable medical device asymmetric key pair is stored in the implantable medical device;
the implantable medical device asymmetric key pair comprises the implantable medical device public key and an implantable medical device private key;
an external device asymmetric key pair is stored in the external device; and
the external device asymmetric key pair comprises the external device public key and an external device private key.

3. The method of claim 2, wherein:
the implantable medical device asymmetric key pair is stored in the implantable medical device prior to conducting the mutual authentication procedure; and
the external device asymmetric key pair is stored in the external device prior to conducting the mutual authentication procedure.

4. The method of claim 2, wherein:
an implantable medical device X.509 certificate is stored in the implantable medical device;
the implantable medical device X.509 certificate comprises the implantable medical device public key;
an external device X.509 certificate is stored in the external device; and
the external device X.509 certificate comprises the external device public key.

5. The method of claim 4, wherein:
the implantable medical device X.509 certificate is less than 512 bytes in size; and
the external device X.509 certificate is less than 512 bytes in size.

6. The method of claim 5, wherein:
the implantable medical device X.509 certificate is signed using Elliptical Curve Digital Signature Algorithm (ECDSA) using P-256 or Secure Hash Algorithm 256 (SHA-256); and
the external device X.509 certificate is signed using Elliptical Curve Digital Signature Algorithm (ECDSA) using P-256 or Secure Hash Algorithm 256 (SHA-256).

7. The method of claim 2, wherein:
an implantable medical device authentication token structure is stored in the implantable medical device;
the implantable medical device authentication token structure comprises the implantable medical device public key;
an external device authentication token structure is stored in the external device; and
the external device authentication token structure comprises the external device public key.

8. (canceled)

9. The method of claim 4, wherein:
the external device transmits the external device X.509 certificate to the implantable medical device;
the external device X.509 certificate was issued by a Public Key Infrastructure Certificate Authority (PKA CA);
the external device public key is encapsulated within the external device X.509 certificate;
the implantable medical device validates the external device public key using a public key of the PKA CA;
the implantable medical device transmits the implantable medical device X.509 certificate to the external device;
the implantable medical device X.509 certificate was issued by the PKA CA;
the implantable medical device public key is encapsulated within the implantable medical device X.509 certificate; and
the external device validates the implantable medical device public key using the public key of the PKA CA.

10. The method of claim 2, wherein the mutual authentication procedure further comprises:
generating, by the external device, an external device random nonce;
transmitting, by the external device, the external device random nonce to the implantable medical device;
generating, by the implantable medical device, an implantable medical device random nonce;
transmitting, by the implantable medical device, the implantable medical device random nonce to the external device;
generating a signed implantable medical device random nonce, by the external device, by signing the implantable medical device random nonce using the external device private key;
generating a signed external device random nonce, by the implantable medical device, by signing the external device random nonce using the implantable medical device private key;
transmitting, by the external device, the signed implantable medical device random nonce to the implantable medical device;
transmitting, by the implantable medical device, the signed external device random nonce to the external device;
verifying, by the implantable medical device, the external device private key using the external device public key; and
verifying, by the external device, the implantable medical device private key using the implantable medical device public key.

11. The method of claim 2, wherein:
the external device generates the shared encryption key using the implantable medical device public key and the external device private key;
the implantable medical device generates the shared encryption key using the external device public key and the implantable medical device private key; and
an Elliptic-curve Diffie Hellman (ECDH) algorithm is used to generate the shared encryption key.

12.-13. (canceled)

14. The method of claim 11, wherein at least some of the wireless transmissions are double encrypted via the shared encryption key and Bluetooth over-the-air (OTA) encryption.

15. A medical system comprising:
an implantable medical device comprising a medical device wireless communication unit and a medical device controller configured to control operation of the implantable medical device and the medical device wireless communication unit; and
an external device comprising an external device wireless communication unit and an external device controller configured to control operation of the external device wireless communication unit,
wherein the external device controller and the medical device controller are configured to:
conduct a mutual authentication procedure that employs asymmetric cryptography via wireless communication between the medical device wireless communication unit and the external device wireless communication unit;
generate a shared encryption key by the external device controller;
generate the shared encryption key by the medical device controller; and
conduct wireless communication between the medical device wireless communication unit and the external device wireless communication unit via wireless transmissions encrypted via the shared encryption key,
wherein the mutual authentication procedure comprises:
wirelessly transmitting an external device public key by the external device wireless communication unit to the medical device wireless communication unit;
validating the external device public key by the medical device controller:
in response to validating the external device public key by the medical device controller, transmitting an external device public key confirmation message by the medical device wireless communication unit to the external device wireless communication unit;
wirelessly transmitting a medical device public key by the medical device wireless communication unit to the external device wireless communication unit;
validating the medical device public key by the external device controller; and
in response to validating the medical device public key by the external device controller, transmitting an medical device public key confirmation message by the external device wireless communication unit to the medical device wireless communication unit.

16. The medical system of claim 15, wherein:
a medical device asymmetric key pair is stored in the medical device controller for use in conducting the mutual authentication procedure and the wireless communication between the medical device wireless communication unit and the external device wireless communication unit;
the medical device asymmetric key pair comprises a medical device public key and a medical device private key;
an external device asymmetric key pair is stored in the external device controller for use in conducting the mutual authentication procedure and the wireless communication between the medical device wireless communication unit and the external device wireless communication unit; and
the external device asymmetric key pair comprises an external device public key and an external device private key.

17. (canceled)

18. The medical system of claim 16, wherein:
a medical device X.509 certificate is stored in the medical device controller;
the medical device X.509 certificate comprises the medical device public key;
the medical device X.509 certificate is less than 512 bytes in size;
the medical device X.509 certificate is signed using Elliptical Curve Digital Signature Algorithm (ECDSA) using P-256 or Secure Hash Algorithm 256 (SHA-256);
an external device X.509 certificate is stored in the external device controller;
the external device X.509 certificate comprises the external device public key;
the external device X.509 certificate is less than 512 bytes in size; and
the external device X.509 certificate is signed using Elliptical Curve Digital Signature Algorithm (ECDSA) using P-256 or Secure Hash Algorithm 256 (SHA-256).

19.-20. (canceled)

21. The medical system of claim 16, wherein:
a medical device authentication token structure is stored in the medical device controller;
the medical device authentication token structure comprises the medical device public key;
an external device authentication token structure is stored in the external device controller; and
the external device authentication token structure comprises the external device public key.

22. The medical system of claim 16, wherein the mutual authentication procedure comprises:
transmitting, by the external device wireless communication unit, the external device public key to the medical device wireless communication unit;
transmitting, by the medical device wireless communication unit, the medical device public key to the external device wireless communication unit;
verifying, by the medical device controller, the external device public key; and
verifying, by the external device controller, the medical device public key.

23. The medical system of claim 22, wherein:
the medical device controller is configured to verify the external device public key using a Public Key Infrastructure (PKI) certificate; and
the external device controller is configured to verify the medical device public key using the PKI certificate.

24. The medical system of claim 22, wherein the mutual authentication procedure further comprises:
generating, by the external device controller, an external device random nonce;
transmitting, by the external device wireless communication unit, the external device random nonce to the medical device wireless communication unit;
generating, by the implantable medical device, a medical device random nonce;
transmitting, by the medical device wireless communication unit, the medical device random nonce to the external device wireless communication unit;
generating a signed medical device random nonce, by the external device controller, by signing the medical device random nonce using the external device private key;
generating a signed external device random nonce, by the medical device controller, by signing the external device random nonce using the medical device private key;
transmitting, by the external device wireless communication unit, the signed medical device random nonce to the medical device wireless communication unit;
transmitting, by the medical device wireless communication unit, the signed external device random nonce to the external device wireless communication unit;
verifying, by the medical device controller, the external device private key using the external device public key; and
verifying, by the external device controller, the medical device private key using the medical device public key.

25. The medical system of claim 16, wherein:
the external device controller generates the shared encryption key using the medical device public key and the external device private key;
the medical device controller generates the shared encryption key using the external device public key and the medical device private key; and
an Elliptic-curve Diffie Hellman (ECDH) algorithm is used to generate the shared encryption key.

26.-27. (canceled)

28. The medical system of claim 25, wherein at least some of the wireless transmissions are double encrypted by via the shared encryption key and Bluetooth over-the-air (OTA) encryption.
